(19) United States
(12) Patent Application Publication
(10) Pub. No.: US 2004/0146289 A1
(43) Pub. Date: Jul. 29, 2004

(54) Electric water heater, liquid heater, steam generator

(76) Inventors: Atsunobu Sakamoto, Shiroi-shi Chiba (JP); Kazuko Sakamoto, Chiba (JP)

Correspondence Address: Atsunobu Sakamoto, 10 15 Minamiyama 3 chome, Shiroi shi Chiba, 270-1423, JP

(21) Appl. No.: 10/475,068

(22) PCT Filed: Apr. 22, 2002
(86) PCT No.: PCT/JP02/03990

(30) Foreign Application Priority Data
Apr. 20, 2001 (JP) 2001-122531

(51) Int. Cl. F24H 1/10; A47J 31/00

(52) U.S. Cl. 392/465

(57) ABSTRACT

An electric water heater, a liquid heater, and a steam generator, wherein the heating wall (2) of a fluid vessel (1) containing water or liquid therein is heated by a heating coil (6) which is formed from a thin—as long as it is self-supporting in shape—and high-electric-resistance metal sheet such as iron and chromium, an electric insulator (5) interposed between the heating wall (2) and the heating coil has a thermal conductivity, of such as aluminum nitride, more than three times higher than that of the heating coil, the heating wall has a thermal conductivity, of such as copper and silver, more than 10 times higher than that of the heating coil, and these components are set to be mutually in close contact in terms of thermal conduction. Accordingly, heating by the heating coil (6) immediately transfers to the heating wall (2) to start feeding water and liquid that has been heated in several seconds, and, in addition, an energy-saving power supply circuit almost free from cold water is available by separately providing a switch turned on several seconds earlier and based on this quick heating.

### CROSS-REFERENCE TO RELATED APPLICATION

This application is a National Phase application derived from PCT Application No. PCT/JP02/03990, filed Apr. 22, 2002, and therefore claims all rights of priority to the parent application, which is also incorporated herein.

### FIELD OF THE INVENTION

The present invention relates to electric water heaters, steam generators, and other fluid heaters, especially those which begin to have an effect within several seconds.

### BACKGROUND OF THE INVENTION

Traditional electric water heaters, fluid heaters, and the like utilize a Nichrome alloy heating wire wrapped in an insulating plate constructed of mica or the like to provide electrical insulation to a pipe through which cold fluids, such as water, is passed and heated. Mica is a superb electrical insulator but at the same time is also an excellent thermal insulator. Therefore, heating fluid to the desired temperature is a slow process, taking two (2) to three (3) minutes and requiring the heating element to be heated nearly to its melting point, reducing its life span.

Combustible gas is generally used for instant water heaters because electric heaters are slow. Gas instant water heaters often must be installed outside the home or office building because ventilation is necessary when such gas is burned and because the equipment reaches high operating temperatures. Therefore, long piping is needed to connect the water heater to the tap or faucet, and, from the time the faucet is opened, 0.5 to 1 minute elapses before hot water is available. In the meantime, a large volume of cold water exits the faucet. After usage, the hot water remaining in the long pipe cools and is wasted.

A prior art water heater, JP-A-H04-278142 to Nakamura, utilizes a partition plate of aluminum nitride, silicon carbide, or the like to increase the thermal exchange rate, but the two (2) cm cross-sectional diameter heater in FIG. 1 of the reference is stated to only provide a means for heat exchange from Nichrome wire. The Nakamura heater utilized no novel technology, so a traditional sheath heater or round Nichrome wire was probably used.

Sheath heaters are water resistant and used often around water, and, as depicted in cross section in FIG. 2E of the present invention, consist of a Nichrome wire 14 covered by a thin stainless steel pipe 15, which is filled with an electrical insulating powder, such as magnesium oxide 16 or the like. The sheath heater is set in close thermally conductive contact with a thermally conductive partition plate 12. However, an extremely long time is required for heat to reach partition plate 12, because the Nichrome wire 14 when wrapped is a poor thermally conductive material. According to the description of this reference, thermal exchange between the partition plate 12 and Nichrome wire 14 reaches equilibrium after approximately ten (10) minutes.

In contrast, the thermal conduction becomes faster for the non-water resistant heater of FIG. 2D of the present invention in which round Nichrome wire 14 is placed in direct contact with an aluminum nitride plate 12. However, it is easily seen that the area of thermal contact is very small, so most of the heat radiates to the surrounding air. Therefore, when compared to the thin Nichrome heating means 11 of FIGS. 2A and 2B, the conduction of heat from round Nichrome wire 14 to aluminum nitride plate 12 is extremely slow.

Furthermore, the heaters of Nakamura passed 5.2 KW through a round silicone carbide plate of a thirty 30 cm diameter, while the present invention passes two (2) KW through a 54 cm² plate, which is five (5) times greater. Accordingly, whether silicone carbide, aluminum nitride, or the like was used in Nakamura, there was no technology capable of beginning to heat within several seconds.

Attempts were made to bake an electrical conductor directly to an aluminum nitride plate, but at present, no suitable material has been produced. The sintering temperature of aluminum nitride is 1.5 times higher than alumina, its thermal expansion rate is ⅔ times lower than alumina, and because of a lack of an oxide compound, there is no appropriate binder. Additionally, because the electric conductor is a not a pure metal, not enough electric current could flow through it. If a suitable material is produced in the future, the present invention will still have considerable value because applying thin Nichrome or iron chrome plate is advantageously simple and cost effective

### BRIEF SUMMARY OF THE INVENTION

A heating wall of a fluid vessel containing water, a liquid, or other fluid is heated by a heating means that is thinned to the limit of maintaining its shape and formed from a metal of high electric resistance. Interposed between the heating wall and the heating means is an electric insulator, such as aluminum nitride, which exhibits thermal conductivity greater than 3 times higher than that of the heating means. The above-mentioned heating wall is constructed of copper, silver, or other suitable material as known to those of skill in the art, and exhibits thermal conductivity greater than 10 times higher than that of the heating means. These components are set in close thermally conductive contact. Through this close thermally conductive contact, the heat is advantageously conducted from the heating means to the heating wall in several seconds.

A separate switch decreases the time users need to wait until heated water flows from the faucet. The heating means is activated by means of a separate switch, preheating the water or liquid contained within the device. Heated water is then allowed to begin flowing by means of opening the faucet and exits preceded by almost no cold water or fluid, thereby saving energy.

### BRIEF DESCRIPTION OF THE DRAWINGS

FIG. 1 is a perspective view showing an example of the water heater of this invention with the heat insulating cover removed.

FIG. 2A is a cross section view which utilizes experimental example to explain the concept between the relationship of this invention's heating means, electrical insulation plate, and heating wall of this invention.

FIG. 2B is a cross section view which utilizes experimental example to explain the concept between the relationship of this invention's heating means, electrical insulation plate, and heating wall of this invention.

FIG. 2C is a cross section view which utilizes experimental example to explain the concept between the relationship of this invention's heating means, electrical insulation plate, and heating wall of this invention.

FIG. 2D is a cross section view which utilizes experimental example to explain the concept between the relationship of this invention's heating means, electrical insulation plate, and heating wall of this invention.

FIG. 2E is a cross section view which utilizes experimental example to explain the concept between the relationship of this invention's heating means, electrical insulation plate, and heating wall of this invention.

FIG. 3 is a cross section view of a different shape of the heating wall and aluminum nitride plate of this invention.

FIG. 4 is a plane view of an example of other applications of the fluid vessel of this invention.

FIG. 5 is a plane view of an example of other applications of the fluid vessel of this invention.

### DETAILED DESCRIPTION OF THE PREFERRED EMBODIMENT OF THE INVENTION

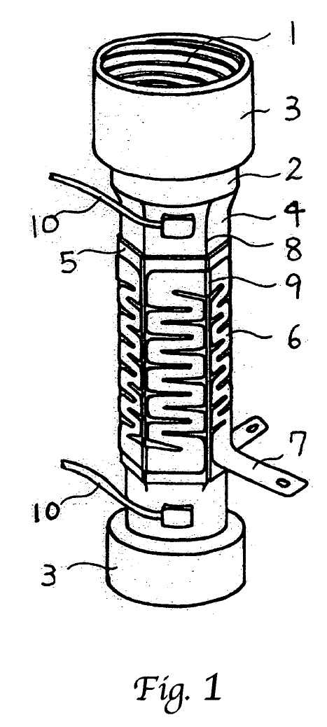

FIG. 1 is a perspective view of one example of the present invention's short, tube-shaped water heater 1 with the heat insulating cover removed for easier view. The fluid vessel 2 is a short copper tube approximately one (1) mm in thickness, both ends of which are flared in shape and attached to flare nuts 3 in order to easily attach to standard fluid-carrying pipes. Located between the ends of fluid vessel 2 are hexagon-shaped, ten (10) mm wide heating walls 4 which are juxtaposed into a hexagonal shape. An approximately 0.6 mm thick sheet of aluminum nitride 5 or the like is attached to the outside of heating walls 4. Heating means 6 is attached to aluminum nitride plate 5.

As in the example of FIG. 1, the heating means 6, is a sheet of iron chrome alloy, appropriately quenched and tempered to be hard and strong enough to be self-supporting in shape when it is 0.1 mm in thickness and two (2) mm in width and runs back and forth latitudinally in a zig-zag pattern, forming 0.5 mm gaps, over the ten (10) mm width of the aluminum nitride 5, which is interposed between hexagonal heating walls 4 and the heating means 6. The heating means 6 may be uniform throughout its extent or have wider areas located at the bends of the zig-zags. Heating wall 4, aluminum nitride sheet 5, and heating means 6 are set in close thermally conductive relationship by a thermal insulating supporter, for example fiberglass, which is wrapped in silicone rubber and caulking materials for the purpose of water proofing.

Next, as an eight (8) Ampelectric current is provided through the electric leads 7, heating means 6 generates heat, but the heat is immediately absorbed by aluminum nitride sheet 5, which has approximately eight (8) times the thermal conductivity of the heating means 4, and is conducted to copper heating wall 4, which has approximately 2.5 times the thermal conductivity of aluminum nitride. Heat is conducted to the interior walls after electric current flows for one (1) second, and after three (3) to five (5) seconds water warmed by this conducted heat begins to exit the device. As a temperature control, temperature sensor 10 is installed upstream and downstream of the heating walls. Alternately, a temperature sensor may be installed together with a mechanical hot and cold water mixer as desired by one of ordinary skill in the art.

In the embodiment of FIG. 1, a two (2) KW electric input requires the hexagonal tube of heating wall 4 to be 50 cm². This means aluminum nitride sheet 5 has a current density of 40 W/cm². According to data on aluminum nitride, it is durable enough to withstand five (5) times this current density, and, because aluminum nitride is expensive, a small-sized sheet is preferable. However, when this current density was increased by 2.5 times to 100 W/cm², the heating means 6 was quickly burned through and cut in an area where it was slightly separated from aluminum the nitride sheet 5. Therefore, the electric density of heating means 6 is considerably lower than that of aluminum nitride, and in the consideration of increased safety, the electric density should be kept low.

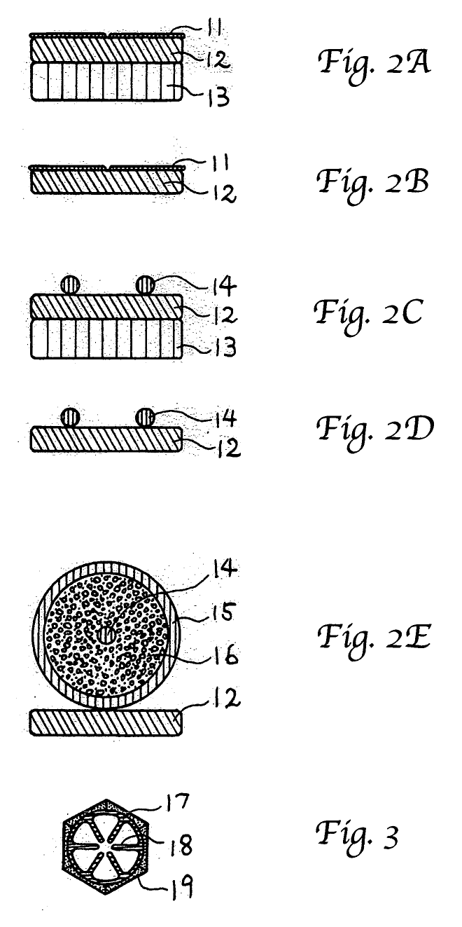

With this current density, thermal conductivity speed experiments were conducted as in FIGS. 2A-2D. FIG. 2A illustrates a 0.6 mm thick four (4) mm wide aluminum nitride sheet 12 interposed between a 0.1 mm thick two (2) mm wide iron chrome heating means 11 and a copper sheet 13. FIG. 2B is the same as FIG. 2A with copper sheet 13 removed. In both cases the gap in heating means 11 is approximately 0.1 mm. In FIG. 2C, the round iron chrome heating wire 14 is 0.5 mm in diameter, has the same cross sectional area as heating means 11, and is attached to the above mentioned aluminum nitride sheet 12 and copper sheet 13, each of which are the same size as in FIG. 2A. FIG. 2D is the same as FIG. 2C expect that copper sheet 13 is removed. In the actual experiments a two (2) mm thick thermal insulator known as Steatite, which is composed of magnesium oxide and silicic acid, was pressed to both sides of the devices pictured in FIGS. 2A-D. An eight (8) A current was passed through each device for one (1) second.

Although this was too short a time for the evaluation to be sufficiently accurate, as in FIG. 2A, the surface of copper sheet 13 that is opposite of heating means 11 reached a temperature of approximately 40-50° C. after one (1) second, while the same surface of the device depicted in FIG. 2C only increased by 1-2° C. In addition, the heating means 11 of FIG. 2A reached a temperature of 50-60° C., which is very low, while, as in FIG. 2C, the portion of round heating wire 14 in contact with the thermal insulator reached 100° C., and the portion not in contact reached in excess of 200° C. The experiments were repeated with an eight (8) A current passed through each device for three (3) seconds. One second after the current ceased, the temperature of each device was measured to be three (3) times higher than in the above experiments.

In FIG. 2B, the surface of aluminum nitride 12 that is opposite of heating means 11 reached a temperature of approximately 150° C. after one (1) second, and the same surface of FIG. 2D reached less than 20° C. Although the device depicted in cross section in FIG. 2E was not tested, it is a four (4) mm outside diameter sheath heater placed on aluminum nitride sheet 12 in the same orientation as the round heating wire 14 of FIG. 2D. It is unknown whether the heating wire is of iron chrome or nichrome, but this arrangement would certainly be slow to conduct heat to aluminum nitride sheet 12.

From the previous experiments it is understood that the heat generated by the thin and wide heating means 11 is conducted ten (10) times faster to the copper sheet 13 than by the round heating wire 14, keeping the temperature of heating means 11 low. Furthermore, if copper plate 13 is removed, aluminum nitride sheet 12 is heated faster, but the accumulated heat is low and heating means 11 is also heated.

The above results show that heat can be generated quickly with both devices of FIGS. 2A and 2B, but that, in the case of FIG. 2B, heating means 11 would heat up and become less solid, necessitating the thickness of the heating means 11 to be increased to 0.5 mm in order to be self-supporting in shape. In addition, because the thermal conductivity of water is low, heat from the aluminum nitride is conducted more efficiently to water contained in a boiler-style fluid vessel, which operates by convection, rather than an ordinary fluid vessel. If this is done, the aluminum nitride receives the difference in heat between the water and heating means, as well as the shock and water hammer caused by instantly boiling water. Since non-stick ceramic is utilized in this application, it must be very structurally strong, and is therefore expensive.

Compared to the above described device, the copper sheet 13 of the device of FIG. 2A absorbs this force, is 1/50^{th} the price of aluminum nitride, and has twice the heat conductivity. If the size of the heating means and the aluminum nitride is made as small as possible and the copper heating wall is made as large as possible, the thermally conductive area will also be increased, providing the means for storing heat. This arrangement will also increase the speed of heat conducted to the water or fluid contained within. Finally, the temperature of the heating means will be kept low making external thermal insulation and waterproofing easily to accomplish.

The conductive area is increased not only by increasing its size, but also by means such as providing fins or projections 18 to the heating wall 17 as in FIG. 3., or by cutting grooves into the heating wall 17. In this case, the heating wall 17 exhibits a tube-like shape and the aluminum nitride 19 becomes the surface which must fit the curved exterior of heating wall 17. Interposed in the gap between the heating wall 17 and the aluminum nitride 19 is a thermally conductive adhesive or grease, such as a mixture of silicone and aluminum nitride, which may take the place of the insulating supporter because the adhesive or grease places heating wall 17 and aluminum nitride 19 in a close thermally conductive relationship. This arrangement is accomplished since the temperature of the heating means is low.

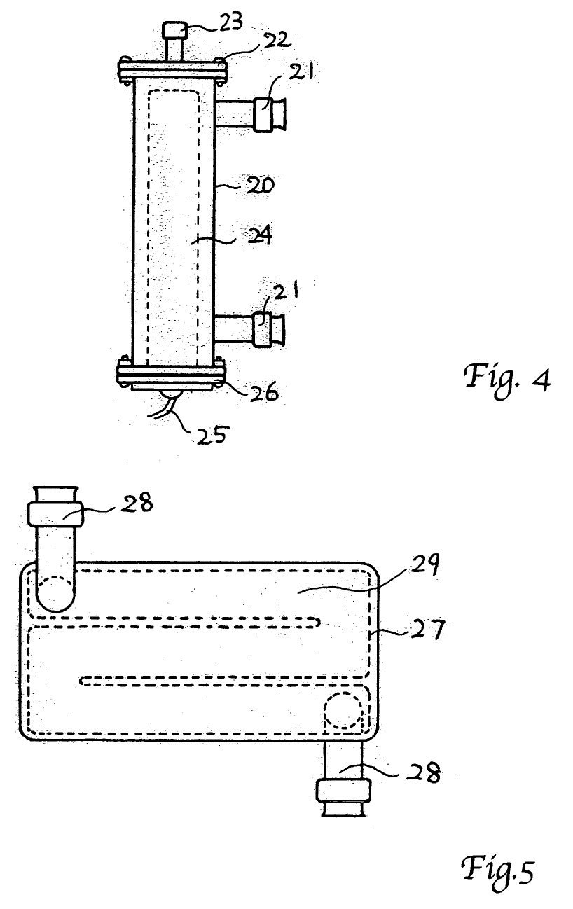

Alternatively, it is possible to increase the electric density and decrease the heated area, creating a boiler-like device to boil the water or fluid contained within. In this case, the heating means 11 of FIG. 2B does not become extremely hot. However, if this is done, minerals dissolved in the water may precipitate on the interior wall, lowering the thermal conductive effect and requiring periodic polishing with citric acid or a similar chemical to remove the precipitate. As in FIG. 1, this may be accomplished by removing the device from to check for buildup of precipitated minerals, etc. Rather than removing the device, a fluid vessel 20, depicted in plane view in FIG. 4, may be employed to divert fluid horizontally at the connectors 21 proximal to both ends of the pipe, allowing flange 22 or valve 23 to be opened for interior inspection.

In this case, heating may be accomplished from the exterior, or, alternatively, a heating wall assembly 24, comprised of a short pipe, aluminum nitride, and heating means, may be inserted from the bottom as depicted by the dotted line in the center of FIG. 4. Heating wall assembly 24 is closed at one end and an aluminum nitride sheet is interposed between the interior wall of the pipe and a heating means. The remaining interior space is then stuffed with an electrical and thermal insulator, such as glass cloth or magnesium oxide powder. From the opposite end, the electrical leads 25 are attached, and the heating wall assembly 24 may be installed into fluid vessel 20 by removing flange 26. Heating wall assembly 24 may then be used separately from fluid vessel 20 as an independent heater for other applications. However, concerning the above-mentioned method of use, this style of heating wall, which may be inserted into a fluid vessel, is included as an additional embodiment of the present invention.

Rather than just a small pipe, the fluid vessel may take various shapes. As in FIG. 5, a rectangular box 27, with inlet and outlet ports 28 and zig-zag water flow path 29, displayed as a dotted line in the FIG. 5, is an alternative embodiment. Aluminum nitride and the heating means may be interposed between the apposed heating walls. Simply, the present invention heats up very rapidly, which may over time result in distortion or metal fatigue, eventually causing cracks or failure of the device. Therefore, a fluid vessel capable of evenly expanding and contracting is desirable.

The present invention is indeed such a device. The ability to absorb thermal expansion and contraction is an intrinsic property of a zig-zag-shaped heating means, which runs back and forth over as short a distance as possible in a zig-zag manner. Furthermore, the heating means may be constructed from materials other than iron chrome, such as Nichrome or tungsten, which are thermally durable as known to those of ordinary skill in the art. However, if a Nichrome heating means is not in close contact with aluminum nitride, it will quickly burn and sever. Therefore, as in FIG. 1, areas 9 of heating means 6 is widened 2-5 times at the corners or the edges of fluid vessel 8 and at heating means leads 7 to prevent heat generation. However, quickly widening areas 9 will concentrate stress in the proximal thinner upstream area, so, as in FIG. 1, areas 9 are widened gradually. Considering these improvements and quenching, heating means 6 may be as thin as 0.1 mm and can still withstand thermal expansion and contraction while being self-supporting in shape without additional support provided by materials such as mica.

Because electric water heaters are susceptible to short-circuiting due to water leaks, waterproofing and a heat insulating cover are included. However, many materials are suitable for the heating means of the present invention because of its low operating temperature, allowing the best materials to be chosen by those of ordinary skill in the art. For example, the device may be rolled in a layer of glass cloth, followed by a layer of silicone rubber, with any gaps filled with caulking material, or, alternatively, covered with a ceramic insulator and then a layer of polyurethane rubber.

There are several suitable materials to provide good thermal conduction and to electrical insulation between the heating means and the heating wall besides aluminum nitride (100-200 W/m K), including diamond (2000 W/m K), cBN (1300 W/m K), silicon carbide (270 W/m K), and beryllium oxide (250 W/m K). However, beryllium oxide is very poisonous; diamond, cBN, and silicon dioxide are difficult to process. Therefore, these materials are not presently usable in this invention, although they maybe available in the future.

Of practically available ceramics, excluding aluminum nitride, alumina (20 W/m K) has the highest thermal conductivity. However, the thermal conductivity of alumina is the same as that of iron chrome. Therefore, its effectiveness did not meet expectations. However, aluminum nitride, with 4-5 times the thermal conductivity of iron chrome, functions adequately, and because there is no practical ceramic with an effectiveness between that of alumina and aluminum nitride, the use of ceramics as an electrical insulator with at least three times the thermal conductivity of iron chrome is contemplated. Alternatively, rather than copper (370 W/m K), silver, (400 W/m K) with a higher heat capacity, may be utilized if cost allows. Alloys principally made of silver and copper along with ceramics principally made of alumina and aluminum nitride attain the same effect and are therefore considered with in the scope of the invention.

The advantages of the present invention over the prior art are not limited to a method for rapid heat generation, but also include the invention's simple structure and low operating temperature of the heating means. Accordingly, the present invention may be applied to tank style water heaters, various fluid heaters, and heating apparatuses, instead of traditional instant electric water heaters.

Furthermore, applying the rapid heat generation of the present invention to instantaneous electric water heaters may reduce the wasting of cold water. Usually water is run from the tap by opening the faucet, which decreases the water pressure within the pipes. In addition to a switch activated by the resulting decrease in water pressure, a separate switch installed above the wash basin for example, when manually actuated, creates a circuit for approximately five (5) seconds to preheat the water contained within the electric water heater, thereby reducing the amount of cold water run from the tap upon opening the faucet and activating the main circuit. Without this preheat circuit, hot water exits the tap within five (5) to seven (7) seconds of opening the faucet, but this time is decreased by five (5) seconds with the usage of the preheat circuit. The time users wait until hot water flows from the faucet is advantageously decreased relative to the instantaneous electric water heaters of the prior art, which require at least 1 min to produce hot water after the faucet is opened.

Before opening the faucet when using the preheating circuit, shorter waiting time is preferable. Alternatively, rather than a manually actuated switch, a motion sensor, activated by the action of standing in front of the wash basin, is also applicable. It is possible for overheating to occur by consecutively activating the preheat circuit many times. Therefore, a temperature sensor to prevent the above mentioned overheating may also be installed.

### INDUSTRIAL APPLICABILITY

The water heater, liquid heater, and steam generator of the present invention, generates heat extremely rapidly, and, therefore, saves energy. In addition, the water heater wastes little cold water and, by design, little hot water remains in the pipes after usage. Furthermore, by activating the present invention's preheat switch several seconds prior to usage, waste of water and energy is further reduced. Indeed time is not wasted either. The heating means and heating walls are small in size and have low operating temperatures, so they can be easily waterproofed and kept warm during operation. Because the entire device is small in size, it is conveniently utilized in portable applications, such as a nursing water heating device. Finally, maintenance is simple and the parts have a long life.

Furthermore, even though the device is high quality, it is very economical because the expensive aluminum nitride sheet is used in minimal quantities. The cost for installation under a wash basin or other like places is also low.

In addition to the above mentioned advantages, which are applicable to instantaneous heating devices, the present invention is also suitable for wide application in water and liquid heaters which operate continuously.

What is claimed is:

1. A device for heating fluids, comprising:
a. a vessel for containment of fluid;
b. a heating means;
c. an electrical insulator interposed between and in close thermal communication with the heating means and the vessel, the insulator adapted to transmit heat from the heating means to the vessel; and
d. a power source connected to the heating means for supplying the power necessary to effect heating of the heating means.

2. The device of claim 1, wherein the electrical insulator is formed of a material having a heat conductivity at least three times greater than the heat conductivity of the heating means.

3. The device of claim 1, wherein the electrical insulator is a ceramic sheet.

4. The device of claim 3, wherein the ceramic sheet is selected from the group consisting of aluminum nitride and silicon carbide.

5. The device of claim 1, wherein the vessel has walls formed of a material having heat conductivity at least ten times greater than the heat conductivity of the heating means.

6. The device of claim 5, wherein the vessel walls are made of of a metal selected form the group consisting of copper, silver and alloys principally made of copper and silver.

7. The device of claim 1, wherein the heating means is a metal selected from the group consisting of an iron chrome and Nichrome.

8. The device of claim, wherein the heating means is an electrical resistance material in a zig-zag shape.

9. The device of claim 8, wherein the heating means is made from a tempered material which is solid and strong enough to be self-supporting in its shape.

10. The device of claim 1, wherein the fluid to be heated is selected from the group consisting of water, steam, and liquids or fluids in general.

11. The device of claim 1, wherein an additional electrical switch is provided for activation of electrical current for a period of several seconds to preheat the fluid prior to activation of the water flow system.

12. A method of a fluid heating device comprising:
a. providing a vessel;
b. providing a heating means;
c. providing an electrical insulator interposed between and in close thermal communication with the heating means and the vessel, the insulator adapted to transmit heat from the heating means to the vessel; and
d. connecting a power source to the heating means for supplying the power necessary to effect heating of the heating means.

13. The method of claim 12, wherein the electrical insulator is selected to be a material having a heat conductivity at least three times greater than the heat conductivity of the heating means.

14. The method of claim 12, wherein the electrical insulator selected is a ceramic sheet.

15. The method of claim 14, wherein the ceramic sheet chosen is selected from the group consisting of aluminum nitride and silicon carbide.

16. The method of claim 12, wherein the vessel provided has walls formed of a material having heat conductivity at least ten times greater than the heat conductivity of the heating means.

17. The method of claim 16, wherein the vessel has walls made of a metal selected from the group consisting of copper, silver and alloys principally made of copper and silver.

18. The method of claim 12, wherein the heating means is a metal selected from the group consisting of an iron chrome and Nichrome.

19. The method of claim 12, wherein the heating means is an electrical resistance material in a zig-zag shape.

20. The method of claim 19, wherein the heating means is made from a tempered material which is solid and strong enough to be self-supporting in its shape.

21. The method of claim 12, wherein the fluid to be heated is selected from the group consisting of water, steam, and liquids or fluids in general.

22. The method of claim 12, wherein there is provided an additional electrical switch for activation of a pre-heat cycle that heats the fluid for several seconds prior to activation of the water flow system.

23. A heating means for use in an electric fluid heater comprising a metal means defined by a series of bends which form a series of zigzags and gaps in the heat generating portion of the heating means.

24. The heating means of claim 23, wherein the heating means is made from a tempered material which is solid and strong enough to be self-supporting in its shape.

25. The heating means of claim 23, wherein the metal is an electrical resistance material.

26. The heating means of claim 23, wherein the heating means is formed of a metal selected from the group consisting of an iron chrome and Nichrome.

27. The heating means of claim 23, wherein the width of the portions not in close contact with the electric insulator is increased.

28. The heating means of claim 23, wherein the zigzags in the heating means are both thin and wide in cross-section.

29. The heating means of claim 23, wherein the fluid to be heated is selected from the group consisting of water, steam, and liquids or fluids in general.
